(19) United States
(12) Patent Application Publication
(10) Pub. No.: US 2006/0182190 A1
(43) Pub. Date: Aug. 17, 2006

(54) Distribution line carrier transmitting device

(75) Inventors: Keiichi Minato, Tokyo (JP); Yasuaki Hori, Tokyo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MITSUBISHI DENKI KABUSHIKI KAISHA, Tokyo (JP)

(21) Appl. No.: 11/325,309

(22) Filed: Jan. 5, 2006

(30) Foreign Application Priority Data
Feb. 17, 2005 (JP) 2005-040433
Aug. 29, 2005 (JP) 2005-247954

(51) Int. Cl. H04K 1/10

(52) U.S. Cl. 375/260

(57) ABSTRACT

There is provided a distribution line carrier transmitting device which supports, for example, frequency division communication and in which even a frequency band used for communication is variable, a filter to be used is changed according to the frequency band, so that an influence of noise is eliminated, and stable communication is enabled. The distribution line carrier transmitting device includes plural filters to selectively attenuate a signal in a band not used for the communication among received signals, and a selection unit to select a specified filter among the plural filters according to an instruction from an external I/F.

### BACKGROUND OF THE INVENTION

1. Field of the Invention

The present invention relates to a distribution line carrier transmitting device which supports, for example, frequency division communication and in which a frequency band used for communication is variable.

2. Description of the Related Art

FIG. 11 is a block diagram showing, in a conventional distribution line carrier transmitting device disclosed in, for example, patent document 1 (JP-A-2001-308755 (page 6, FIG. 1)), a use method of a filter to attenuate high-level noise which interferes with and disturbs communication. In FIG. 11, reference numeral 1 denotes a distribution line of commercial power source as a distribution line carrier transmission path; and 2, a control circuit which includes a microprocessor and controls respective parts of the transmitting device. Reference numeral 3 denotes a coupling circuit which allows a high frequency communication signal to pass through between the transmitting device and the distribution line 1 and prohibits a commercial frequency from passing through. One of the input and output is connected to the distribution line 1 through the coupling circuit 3, and the other is connected to a not-shown input/output device. Besides, the transmitting device includes a transmission processing system and a reception processing system.

First, a structure of the transmission processing system will be described. Reference numeral 4 denotes a framing circuit to translate digital transmission data from the input/output device into transmission format; and 5, a primary modulator which performs a processing to superimpose the formatted transmission data on a carrier wave. Reference numeral 6 denotes a frequency selector to select the carrier wave; and 7, an inverse fast Fourier transform circuit (IFFT circuit) which carries out inverse Fourier transform of the inputted data and generates transmission data combined with carrier wave number. Reference numeral 8 denotes a parallel/serial conversion circuit (P/S conversion circuit) to rearrange the transmission data in serial; and 9, a digital/analog conversion circuit (D/A conversion circuit) which converts the digital transmission data into analog data. The transmission data converted into the analog data is sent to the distribution line 1 through the coupling circuit 3.

Next, a structure of the reception system will be described. Reference numeral 11 denotes an analog/digital conversion circuit (A/D conversion circuit) to perform digital conversion of analog received data inputted through the coupling circuit 3; and 12, a serial/parallel conversion circuit (S/P conversion circuit) which converts the inputted distribution line carrier signal into parallel data. Reference numeral 13 denotes a fast Fourier transform circuit (FFT circuit) which carries out Fourier transform of the inputted digital data and decomposes it into individual frequency components. Reference numeral 14 denotes a frequency selector which selects an individual frequency of the decomposed received data and transmits the frequency value to the control circuit 2. Reference numeral 15 denotes a primary demodulator which demodulates the data modulated with the carrier frequency selected by the frequency selector 14. Reference numeral 16 denotes a deframing circuit which translates the demodulated data from the primary demodulation circuit 15 into reception format and outputs it as received data to the input/output device.

Next, a filter circuit to attenuate high-level noise will be described. Reference numeral 30 denotes a through circuit, the conduction/non-conduction of which can be controlled from the control circuit 2 and which has no filter function at the time of the conduction and allows all frequencies to pass through as they are. Reference numeral 31 denotes a high pass filter (HPF) to reduce a voltage of frequency of not higher than a lowest frequency f1 among plural distribution line carrier signal frequencies used for the distribution line carrier transmission; 32, a first band elimination filter (BEF) to attenuate a frequency component between the distribution line carrier signal frequency f1 of the lowest frequency and a next distribution line carrier signal frequency f2; 33, a secondband elimination filter (BEF) to attenuate a frequency voltage component between the distribution line carrier signal frequency f2 and a distribution line carrier signal frequency f3 of a next higher frequency; 34, a lowpass filter (LPF) to attenuate a frequency component not lower than a distribution line carrier signal frequency f3 of a highest frequency among the distribution line carrier signal frequencies; and 35, a selector to control the operations of the plural filters 31 to 34 and the through circuit 30 by the control from the control circuit 2. The respective filters 31 to 34 and the through circuit 30 are connected in parallel to each other between the coupling circuit 3 and the A/D conversion circuit 4.

When a signal is received, a conversion width of the A/D conversion circuit 11 is determined by a noise voltage. In the case where the highest signal level is not within the band of signals used for communication and the signal is an external noise, since the conversion width of the A/D conversion circuit 11 is determined by the noise voltage, in order to cut the noise voltage, a filter is provided in front of the A/D conversion circuit 11, and in the case where the maximum level signal is other than the frequency used for signal carrying, the frequency band is filtered, and the decoding processing is performed only when the maximum level signal is a frequency used for signal carrying.

When the highest signal level is the noise voltage, the conversion width of the A/D conversion circuit 11 is controlled by the noise, and the performance deteriorates, and therefore, it is necessary that the original signal has the highest signal level. In the conventional distribution line carrier transmitting device, as shown in FIG. 12, the plural frequency bands of f1, f2 and f3 are simultaneously used to perform communication, and in the case where a high-level signal exists in an unused frequency band, it is judged to be a noise. However, in order to construct a network, plural communication channels are required, and in order to realize the conventional communication using the distribution line, since the communication line can not be separated, unless the frequency is separated, only one communication channel can be prepared. That is, in order to realize network communication by the distribution line, it is necessary to divide and use the frequency band. Thus, since it is necessary to attenuate a signal in a frequency band which is a communication band in another node, it is necessary to use a suitable filter for each frequency band to be used. This becomes especially important in a frequency division repeater. As shown in FIG. 9, the repeater performs distribution line communication between a modem device A and a modem device B and between a modem device C and a modem device D, and performs communication between the modem device B and the modem device C by another communication unit such as Ethernet (registered trademark). At this time, it is desired that a signal transmitted from the modem device A is received by the modem device B, and a signal transmitted from the modem device C is received by the modem device D. However, at this time, as shown in FIG. 10, the signal transmitted by the modem device C is seen to be larger than the signal transmitted by the modem device A for the modem device B. A partner with which the modem device B wants to communicate is the modem device A, and it is necessary to use a filter to perform attenuation so that communication can be performed in the band F1 and the modem device B does not receive the signal in the band F2. As stated above, depending on a band used for communication, the band which is used in other communication must be filtered.

In order to deal with this, it is also possible to use a method in which a filter to attenuate a specific communication band is mounted to the outside of a device, and a filter is exchanged according to a band used for communication to deal with the case where the band used for the communication is variable. However, the installation place of this device is the vicinity of a transformer installed on an electric pole or the vicinity of a transformer buried in the ground, that is, the device is installed at a place where a filter can not be easily changed, and it is difficult to exchange the filter one by one for the installed equipment.

### SUMMARY OF THE INVENTION

The invention has been made to solve the problems as described above, and has an object to provide a distribution line carrier transmitting device in which even if a frequency band used for communication is variable, a filter to be used is changed according to the frequency band, so that an influence of noise is eliminated, and stable communication is enabled.

According to an aspect of the invention, a distribution line carrier transmitting device, which supports, for example, frequency division communication and in which a frequency band used for communication is variable, includes plural filters to selectively attenuate a signal in a band not used for communication among received signals, and a selection unit to select a specified filter among the plural filters according to an instruction from an external I/F.

According to the distribution line carrier transmitting device of the invention, since the filter of the band used for the communication can be selected fromthe received signals by the instruction from the external I/F, connection to a center is performed by, for example, a distribution line or an optical fiber, and the frequency band of the filter can be changed remotely by using distribution line communication or Ethernet (registered trademark) communication, or the frequency band of the filter can be changed by remote control using a remote or the like from the vicinity of the device.

### BRIEF DESCRIPTION OF THE DRAWINGS

FIG. 1 is a block diagram showing a structure of embodiment 1 of the invention.

FIG. 2 is a view showing an example of frequency bands used for communication and filter in embodiment 1.

FIG. 3 is a flowchart for explaining an operation of embodiment 1 of the invention.

FIG. 4 is an explanatory view of communication frequency assignment in embodiment 2 of the invention.

FIG. 5 is a block diagram showing a structure of embodiment 2 of the invention.

FIG. 6 is a block diagram showing a structure of embodiment 3 of the invention.

FIG. 7 is a block diagram showing a structure of embodiment 4 of the invention.

FIG. 8 is a block diagram showing a structure of embodiment 5 of the invention.

FIG. 9 is an explanatory view showing the role of a repeater in a distribution line carrier transmission system.

FIG. 10 is an explanatory view of signals received by modem devices in the repeater in the distribution line carrier transmission system.

FIG. 11 is ablock diagram of a conventional distribution line carrier transmitting device.

FIG. 12 is an explanatory view of communication frequency assignment of the conventional distribution line carrier transmitting device.

### DETAILED DESCRIPTION OF THE INVENTION

### Embodiment 1

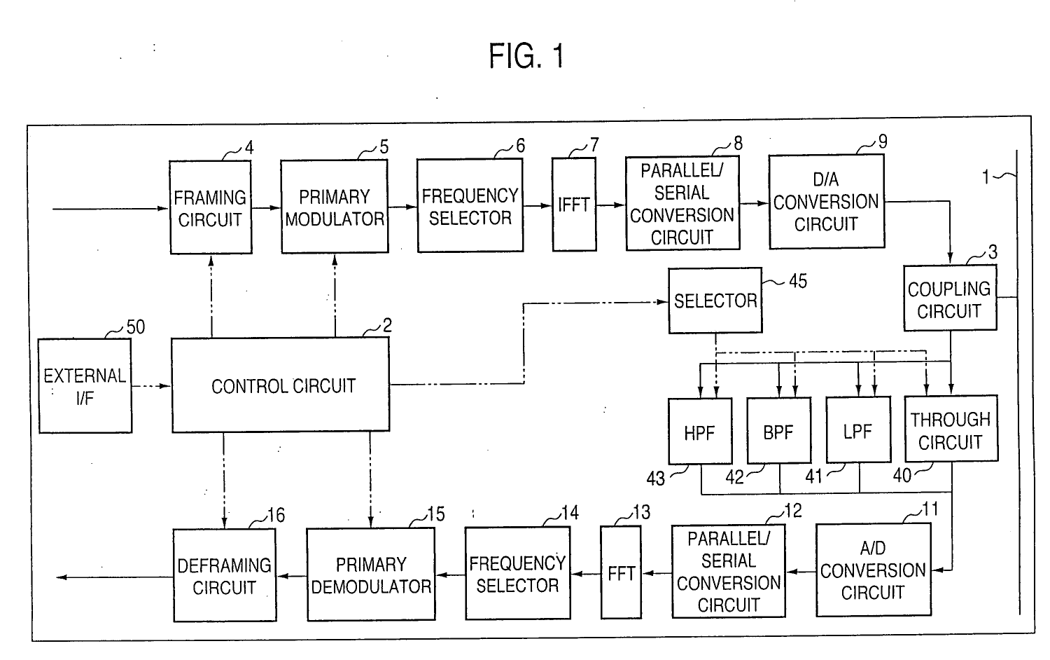

Hereinafter, embodiment 1 of the invention will be described with reference to FIG. 1.

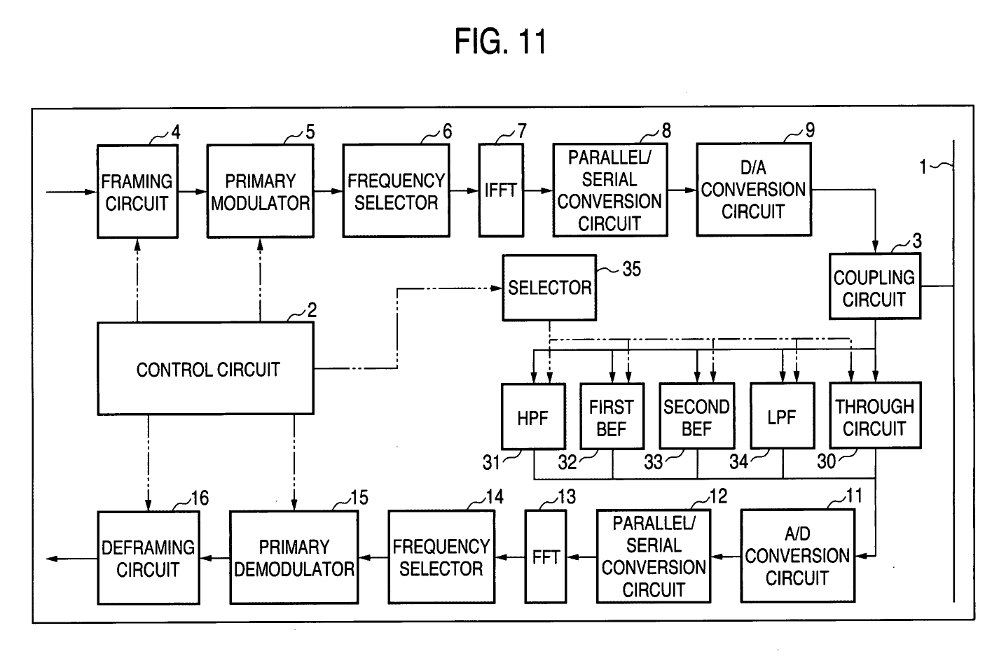

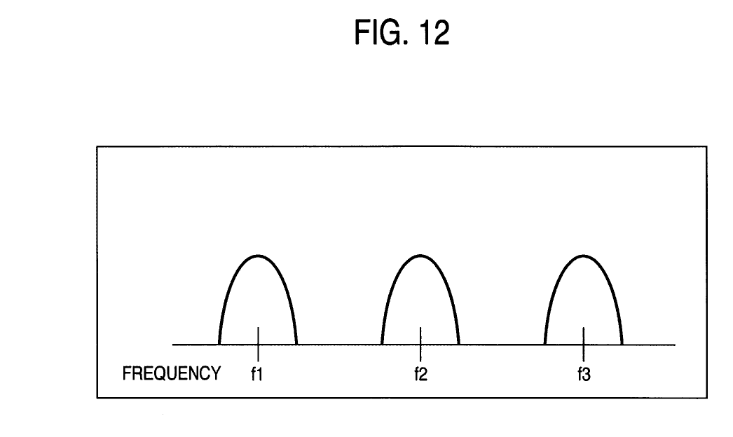

Reference numerals 1 to 16 denote the same parts as those in FIG. 11. Reference numeral 40 denotes a through circuit, the conduction/non-conduction of which can be controlled from the control circuit 2 and which has no filter function at the conduction and allows all frequencies to pass through as they are. Reference numeral 41 denotes a low pass filter (LPF) which reduces a voltage on the high band side outside a use voltage in the case where the lowest band is used in the distribution line carrier transmission; 42, a band pass filter (BPF) which reduces a voltage on the low band side and high band side outside a use band in the case where an intermediate band is used in the distribution line carrier transmission; 43, a high pass filter (HPF) which reduces a voltage on the low band side outside a use band in the case where the highest frequency band is used in the distribution line carrier signal frequency; and 45, a selector which controls the operations of the plural filters 41 to 43 and the through circuit 40 by the control from the control circuit 2. The respective filters 41 to 43 and the through circuit 40 are connected in parallel to each other between the coupling circuit 3 and the A/D conversion circuit 4. Reference numeral 50 denotes an external I/F (interface), such as Ethernet (registered trademark) interface or wireless interface, which can operate the selector 45 through the control circuit 2 by communication using the distribution line, Ethernet (registered trademark) communication, or wireless communication with remote control from a remote.

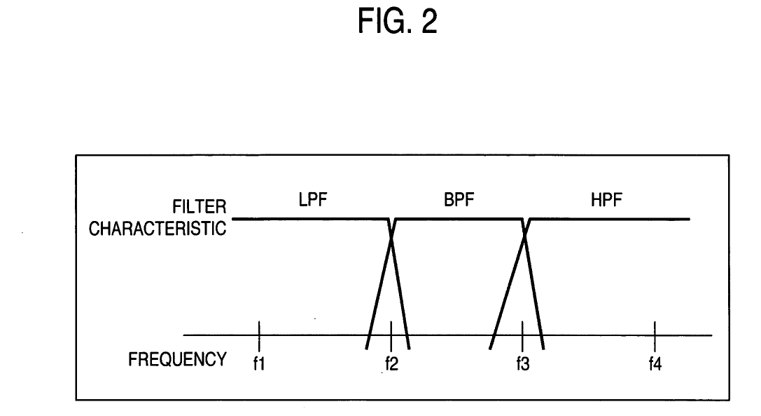

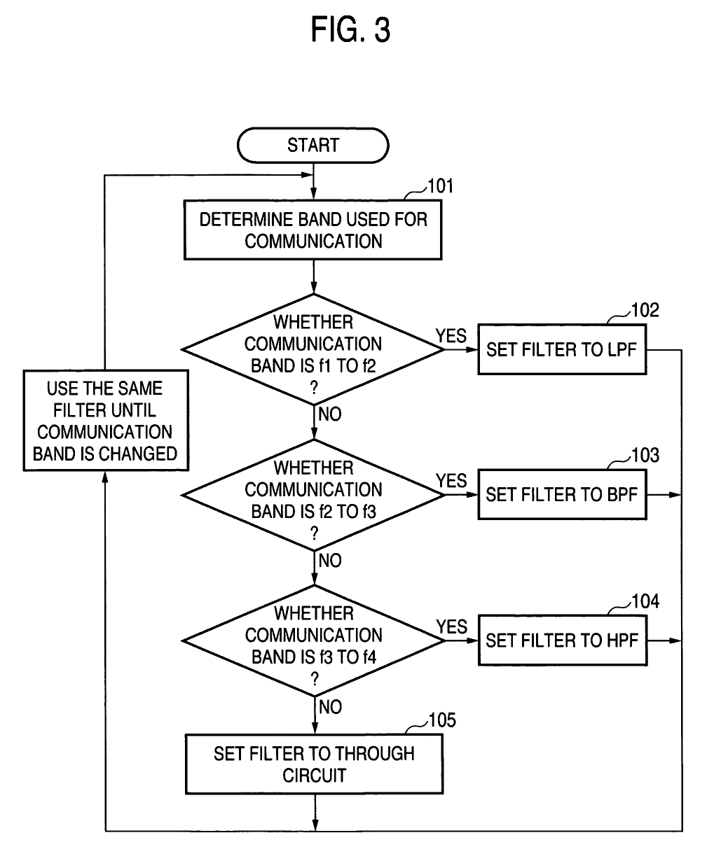

Next, an operation will be described. The control circuit 2 receives instructions from the external I/F and determines the band used for communication. At that time, a filter to be used is changed so as to attenuate signals outside the communication band according to the band to be used for the communication. For example, consideration will be given to a case where as shown in FIG. 2, communication is performed using four kinds of bands of f1 to f2, f2 to f3, f3 to f4, and f1 to f4. At that time, it is assumed that there are an LPF to allow communication in a band of not higher than f2 to pass through, a BPF to allow communication in a band between f2 to f3 to pass through, and an HPF to allow communication in a band of not lower than f3 to pass through. The operation at this time will be described using a flowchart of FIG. 3. First, the control circuit 2 determines a band to be used for communication (step 101). In the case where the band of f1 to f2 is used, a filter is changed to the LPF which allows the band of not higher than f2 to pass through and attenuates the band of not lower than f2 (step 102). Similarly, in the case where the band of f2 to f3 is used, a filter is changed to the BPF which allows a signal only in the band of f2 to f3 to pass through and attenuates a signal in the band of not higher than f2 and in the band of not lower than f3 (step 103). In the case where the band of f3 to f4 is used, a filter is changed to the HPF which allows a signal in the band of not lower than f3 to pass through and attenuates a signal in the band of not higher than f3 (step 104). Besides, as in the case where the band of f1 to f4 is selected, in the case where a specific filter can not be used, the through circuit is selected (step 105). In the case where the band of the communication is changed after the selection of the filter, the filter to be used is similarly selected again.

As stated above, according to this embodiment, in the distribution line carrier transmitting device in which the frequency band used for communication is variable, there are provided the plural filters to selectively attenuate a signal in a band not used for the communication among received signals, and the selection unit to select a specified filter among the plural filters, the filter is changed according to the band used for the communication to change the passband and the cut-off band, and accordingly, it is possible to easily deal with the communication in which the frequency is divided. Besides, since the band and the filter to be used for the communication can be changed by the instructions from the external I/F, connection to the center is performed by, for example, a distribution line, an optical fiber or the like, and the frequency band of the filter can be changed using the distribution line communication or Ethernet (registered trademark) communication, or the frequency band of the filter can be changed by remote control using a remote or the like from the vicinity of the device. Thus, since the communication band can be changed without physically exchanging a filter body, even after equipment is installed, the network structure can be flexibly changed.

Incidentally, in this embodiment, although the filter is inserted between the coupling circuit 3 and the A/D conversion circuit 11, even if it is inserted between the coupling circuit 3 and the distribution line 1, a similar effect can be obtained.

### Embodiment 2

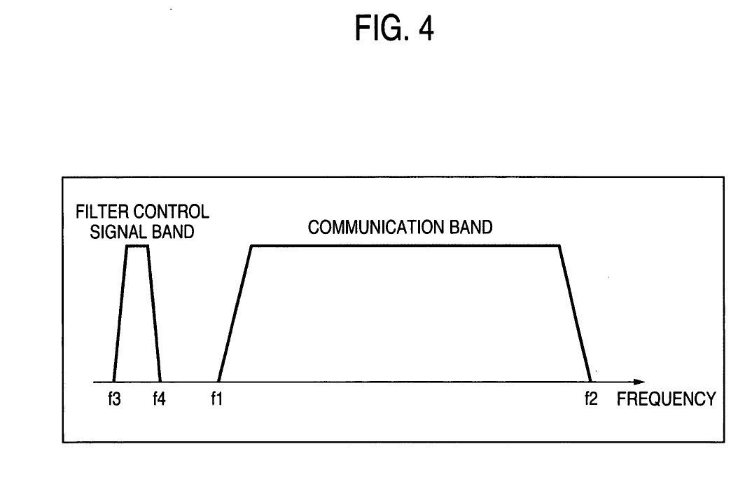

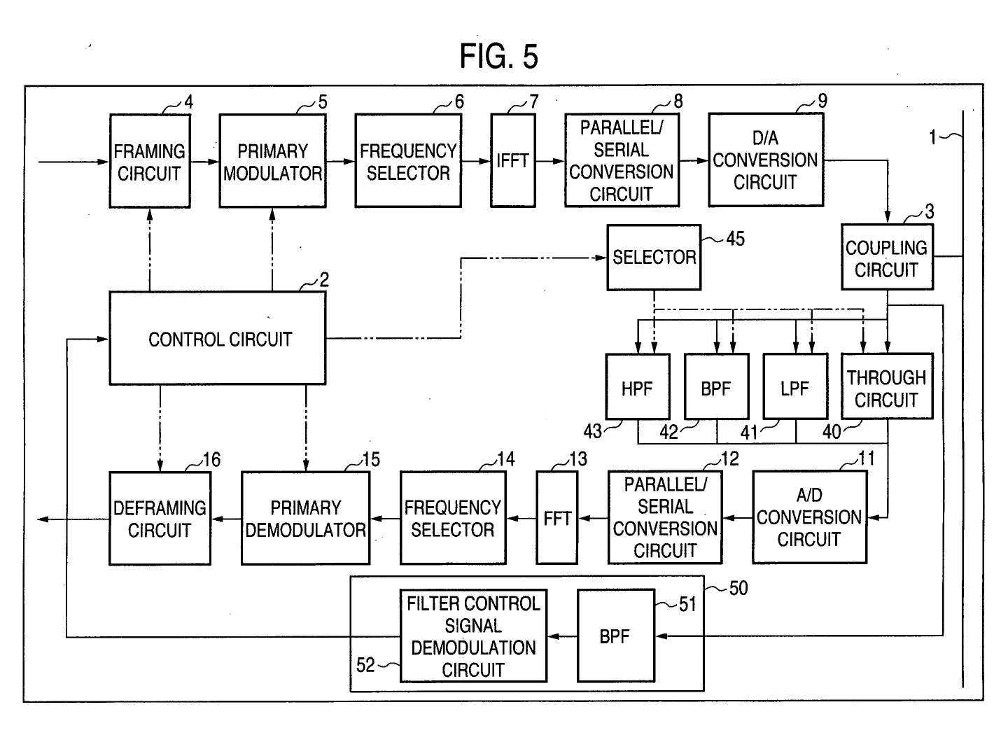

In embodiment 1, although the switching of the filter is realized using the distribution line communication, even in a method of using the same distribution line communication, as shown in FIG. 4, there is a method in which a band different from a normal communication band is prepared for filter control. In this embodiment, an external I/F 50 is a distribution line communication I/F, and as shown in FIG. 5, a band pass filter 51 dedicated for a filter control signal and a demodulation circuit 52 dedicated for a filter control signal are provided to branch from a coupling circuit 3, and when a band of from f1 to f2 is a normal communication band, communication dedicated for filter control is performed using a band, like a band of from f3 to f4, different from the band of from f1 to f2.

In this embodiment, in the case where a filter control signal is received, the signal is processed by the circuit dedicated for the filter control signal, that is, the band pass filter 51 and the demodulation circuit 52, not circuits 11 to 16 to process a normal distribution line communication signal. A signal in a band other than the filter control signal is attenuated by the band pass filter 51, and the signal is demodulated by the demodulation circuit 52. The result is notified to the control circuit 2, and the control of filters 41 to 43 is performed based thereon. By this, even in the case where the voltage level of a signal used for different communication is larger than the voltage level of a signal already used for communication and communication using a normal band can not be performed, the filter can be controlled by the distribution line communication.

### Embodiment 3

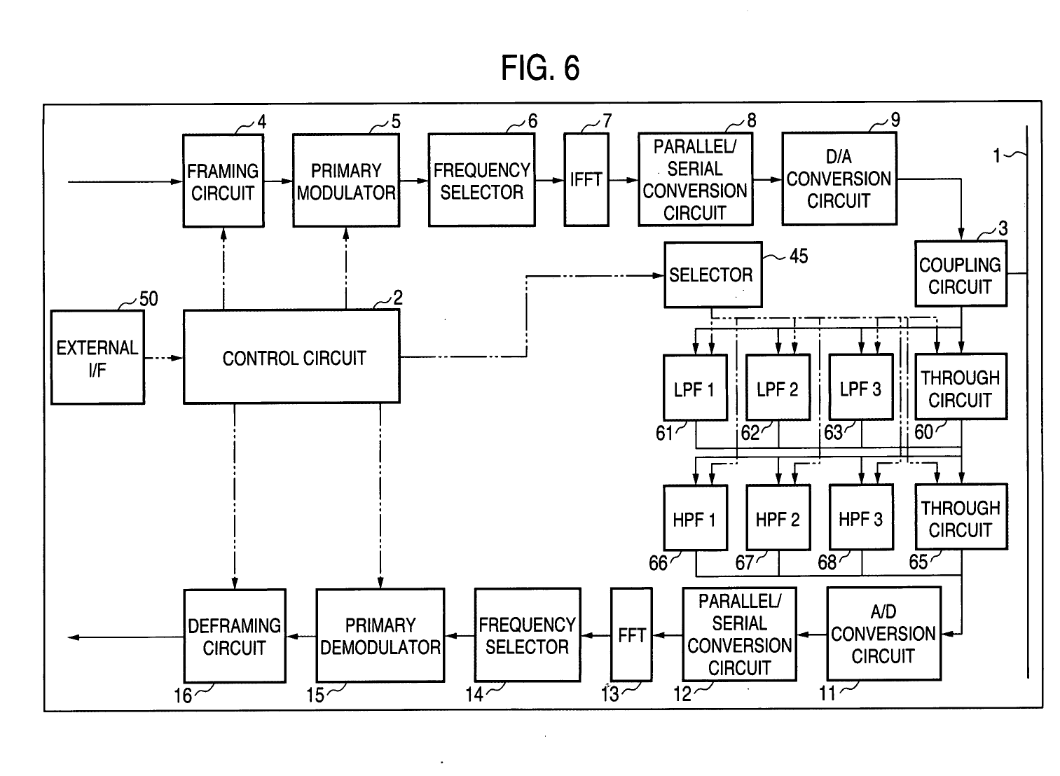

In embodiment 1, although one of the low pass filter, the band pass filter, the high pass filter and the through circuit is selected according to the band used for the communication, there is a method in which as a filter, a high pass filter and a low pass filter are combined in a multi-stage configuration. Embodiment 3 using this method will be described with reference to FIG. 6. Reference numerals 61 to 63 denote low pass filters corresponding to different frequency bands; and 66 to 68, high pass filters corresponding to different frequency bands. Reference numerals 60 and 65 denote through circuits.

In this embodiment, a selector 45 is operated based on instructions from an external I/F 50, one kind is selected from the high pass filters 60 to 63, and one kind is selected from the low pass filters 65 to 68. By this, filters corresponding to sixteen kinds of bands can be realized from eight kinds of filters. That is, by this method, filters corresponding to frequency bands of kinds, whose number is not lower than the number of filters mounted on the circuit, can be realized.

### Embodiment 4

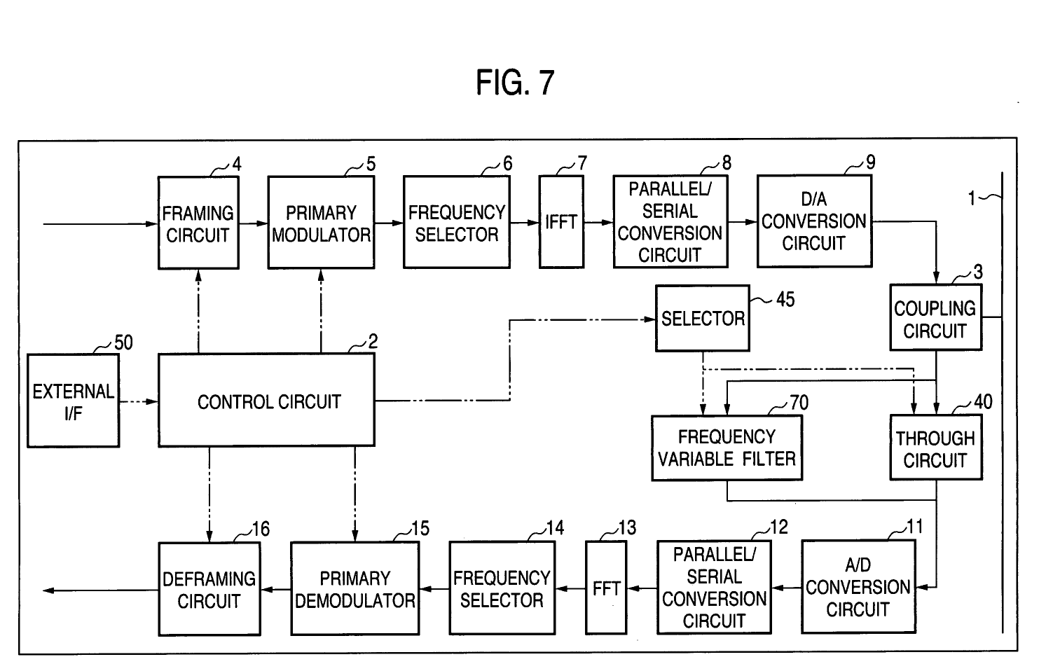

In embodiments 1 to 3, although the filter to be used is changed according to the band used for communication, there is a method in which the characteristic of a filter is changed according to a band to be used for communication. Embodiment 4 using this method will be described with reference to FIG. 7. Reference numeral 70 denotes a frequency variable filter capable of changing a frequency band. The characteristic of the filter can be changed by changing constants of parts of the inside the frequency variable filter in accordance with instructions from the outside.

In this embodiment, a selector 45 is operated from an external I/F 50, and a value of the frequency variable filter 70 is changed to obtain a desired filter characteristic. Incidentally, in order to change constants of parts in the frequency variable filter 70, for example, when a variable resistor is used, a motor and a slidac are prepared, and the position of a contact of the resistor has only to be changed by using the motor to move the position of the slidac in accordance with the instruction of the selector. By this method, the communication of plural frequency bands can be dealt with without providing plural filters. In the above example, although the description has been given to the example in which the number of frequency variable filters is one, plural frequency variable filters are prepared, and the filter switching and filter characteristic change may be combined at the same time.

### Embodiment 5

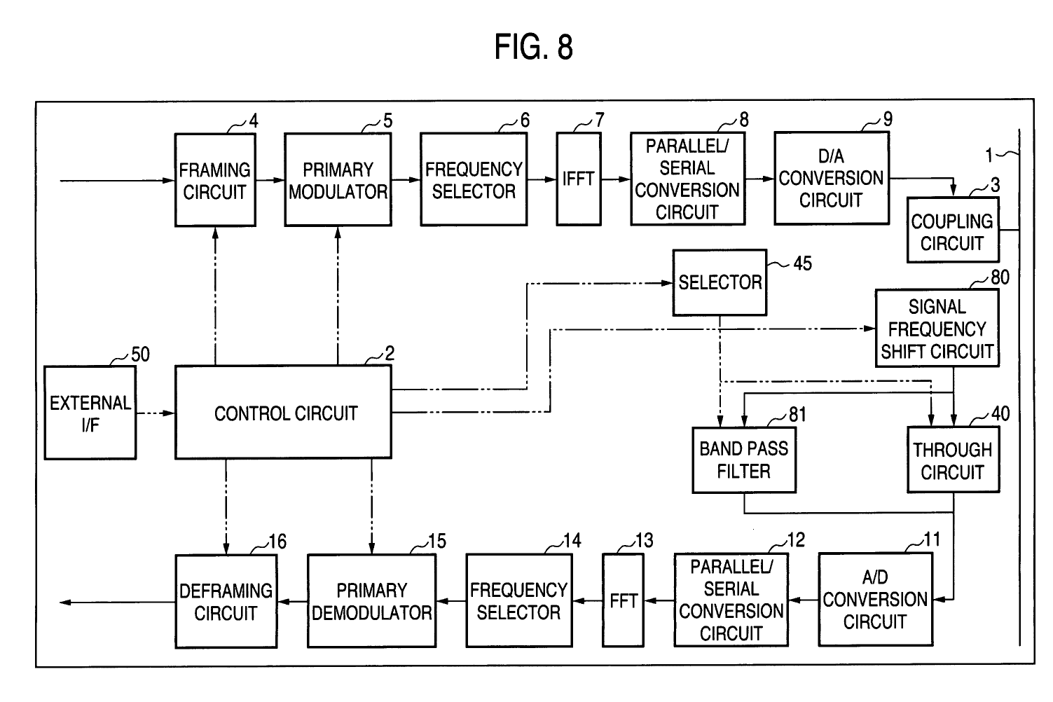

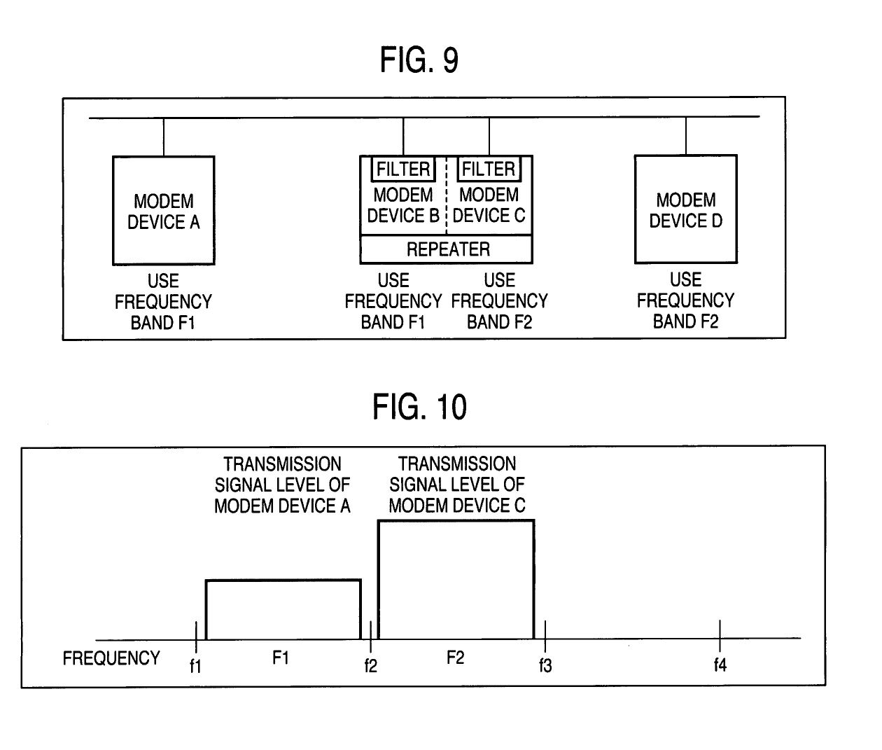

In embodiments 1 to 4, although the filter to be used is changed according to the band used for communication, there is a method in which a frequency band of a signal at the time when it passes through a filter is shifted according to the filter of the device. Embodiment 5 using this method will be described with reference to FIG. 8. Reference numeral 80 denotes a signal frequency shift circuit which can arbitrarily shift a frequency in accordance with a control. Reference numeral 81 denotes a band pass filter to allow only a signal in a specific frequency band to pass through.

In this embodiment, when the device receives a signal from a distribution line 1, the shift width of the frequency of the communication signal is instructed from a control circuit 2 to the signal frequency shift circuit 80 so that the frequency band of the signal is coincident with the passband of the band pass filter 81. In accordance with the instruction, the signal frequency shift circuit 80 performs the frequency shift of the communication signal. In this method, since the communication signal is changed according to the frequency of the filter, a communication signal in an arbitrary frequency band can be made to pass through without preparing plural filters, and a signal of a frequency other than that can be attenuated. Incidentally, in FIG. 8, since only one band pass filter is provided, it is impossible to deal with a communication system in which plural band widths are selectively used, however, such a communication system can be dealt with by preparing band pass filters corresponding to the respective band widths used for communication and by enabling a use filter to be selected according to the band width of the communication signal.

Incidentally, in embodiments 1 and 3 to 5, even if the external I/F 50 is a manually operated I/F, such as a dip switch, a slide knob, or a volume knob, when the selector 45 is operated according to its movement and the filter is changed, the equivalent effect can be obtained. This is effective in the case where although it is unnecessary that the filter can be remotely operated, it is desired to determine, in the place where the device is installed, not the time of shipment, which filter is used.

What is claimed is:

1. A distribution line carrier transmitting device in which a frequency band used for communication is variable, comprising:
plural filters to selectively attenuate a signal in a band not used for the communication among received signals; and
a selection unit to select a specified filter among the plural filters according to an instruction from an external interface.

2. The distribution line carrier transmitting device according to claim 1, wherein the plural filters include a low pass filter to reduce a voltage on a high band side outside a use band, a band pass filter to reduce a voltage on a low band side and on a high band side outside a use band, and a high pass filter to reduce a voltage on a low band side outside a use band.

3. The distribution line carrier transmitting device according to claim 1, wherein the selection unit is controlled through a control circuit operating according to the instruction from the external interface.

4. The distribution line carrier transmitting device according to claim 1, wherein the external interface is one of a distribution line, an Ethernet (registered trademark) interface, and a wireless interface.

5. The distribution line carrier transmitting device according to claim 1, wherein the external interface is one of a dip switch, a slide knob, and a volume knob and can be manually operated.

6. The distribution line carrier transmitting device according to claim 1, wherein the external interface is a distribution line, and a band different from the band used for the communication is used for filter control.

7. The distribution line carrier transmitting device according to claim 1, wherein high pass filters and low pass filters are combined in a multi-stage configuration and are used as the plural filters.

8. A distribution line carrier transmitting device in which a frequency band used for communication is variable, comprising:
at least one frequency variable filter to selectively attenuate a signal in a band not used for the communication among received signals; and
a unit to change a filter characteristic of the frequency variable filter according to an instruction from an external interface and according to a frequency band used for the communication.

9. A distribution line carrier transmitting device in which a frequency band used for communication is variable, comprising:
at least one filter to attenuate a signal in a specific band;
a circuit to shift a frequency band of a communication signal, which is provided at a front stage of the filter; and
a unit to attenuate a signal outside the communication band with the filter by shifting the frequency band of the communication signal according to an instruction from an external interface.

10. The distribution line carrier transmitting device according to claim 8, wherein the external interface is one of a distribution line, an Ethernet (registered trademark) interface, and a wireless interface.

11. The distribution line carrier transmitting device according to claim 9, wherein the external interface is one of a distribution line, an Ethernet (registered trademark) interface, and a wireless interface.

12. The distribution line carrier transmitting device according to claim 8, wherein the external interface is one of a dip switch, a slide knob, and a volume knob and can be manually operated.

13. The distribution line carrier transmitting device according to claim 9, wherein the external interface is one of a dip switch, a slide knob, and a volume knob and can be manually operated.
